(19) United States
(12) Patent Application Publication
(10) Pub. No.: US 2002/0003812 A1
(43) Pub. Date: Jan. 10, 2002

(54) Telecommunications systems

(76) Inventor: Jacobus Cornelis Haartsen, Hardenberg (NL)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/884,114

(22) Filed: Jun. 20, 2001

(30) Foreign Application Priority Data
Jun. 21, 2000 (GB) 0015199.3

(51) Int. Cl. H04J 3/24

(52) U.S. Cl. 370/474

(57) ABSTRACT

In packet-based communications systems, quality of voice channels in the presence of interference is improved by processing voice payload data of a data packet even if header data of the packet includes errors.

### FIELD OF THE INVENTION

The invention relates to telecommunications systems, and in particular to packet-based communication systems supporting synchronous or isochronous services such as voice or video under error-prone conditions such as in a radio environment.

### BACKGROUND OF THE INVENTION

In the last decades, progress in radio and VLSI (very large scale integration) technology has fostered widespread use of radio communications in consumer applications. Portable devices, such as mobile telephones, can now be produced with acceptable cost, size and power consumption.

Although wireless technology is today focussed mainly on cellular communications where a user is connected to a fixed infrastructure via radio base stations and portable handsets, a new area of radio communications is emerging which provides short-range connectivity between nomadic devices such as laptop computers, mobile phones, PDAs (personal digital assistants) and notebook computers. Further advances in technology will provide very inexpensive radio equipment, which can be easily integrated into many devices. This will reduce the number of cables currently used. For instance, radio communication can eliminate or reduce the number of cables used to connect master devices with their respective peripherals. The aforementioned radio communications will require an unlicensed band with sufficient capacity to allow for high data rate transmissions. A suitable band is the ISM (Industrial, Scientific and medical) band at 2.45 GHz, which is globally available. The band provides 83.5 MHz of radio spectrum.

By definition unlicensed bands allow all kinds of radio systems to operate in the same medium. This gives rise to mutual interference. To reduce interference and allow a fair access to every user, signal spreading is usually applied. Spreading provides immunity to other systems and jammers sharing the band. In fact, the FCC in the United States currently requires radio equipment operating in the 2.45 GHz band to apply some form of spreading when the transmit power exceeds about 0 dBm. Spreading can either be at the symbol level by applying direct-sequence (DS) spread spectrum or at the channel level by applying frequency hopping (FH) spread spectrum. The latter is attractive for the radio applications mentioned above since it more readily allows the use of cost-effective radios. A radio interface called Bluetooth™ was recently introduced to provide connectivity in particular between units such as mobile telephones, laptops, PDAs and other nomadic devices. The Bluetooth system applies frequency hopping to enable the implementation of low-power, low-cost radios with a small footprint. The system supports both data and voice services. The latter is optimized by applying fast frequency hopping with a nominal rate of 800 hops/s through the entire 2.45 GHz ISM in combination with a robust voice coding technique. Devices based on the Bluetooth system concept can create so called piconets, which consist of a master device, and one or more slave devices connected via the FH piconet channel. The FH sequence used for the piconet channel is completely determined by the address or identity of the device acting as the master. The system clock of the master device determines the phase in the hopping sequence. In the Bluetooth system, each device has a free-running system clock. The slave devices add a time offset to their clocks such that they become aligned with the clock of the master device. By using the master address to select the proper hopping sequence and by using the time offset to align to the master clock, the slave devices keep in hop synchrony to the master device; i.e. master and slave devices remain in contact by hopping synchronously to the same hop frequency or hop carrier. For more details, the reader is referred to US patent application “FH piconets in an uncoordinated wireless multi-user system”, by J. C. Haartsen, U.S. Ser. No. 08/932,911 filed on Sep. 18, 1997.

The Bluetooth air interface can provide both synchronous and asynchronous connections in order to support multi-media applications. The Bluetooth link makes use of time slots that correspond to the hop dwell time. In each slot, a master can send or receive a packet. Transmission and reception alternate, that is half of the slots are used for master-to-slave transmission and half of the slots are used for slave-to-master transmission. Asynchronous connections make use of a packet-switching technique. Each packet contains a slave address; at each master transmission, the master can decide which slave to address. A slave address is allowed to respond in the following slave-to-master slot. Synchronous connections are established by reservation of specific synchronous time slots which are repeated at a fixed interval. At link establishment, master and slave negotiate for the synchronous time slots and their positioning. Packets sent on these reserved time slots carry synchronous data like voice. Although sent on reserved slots, these synchronous packets have the same appearance as the asynchronous packets, so they also include the slave address. For example, in Bluetooth, a packet consists of three fields: a preamble, a packet header, and a payload. The preamble is used for bit synchronization and frame delimiting; the packet header contains link supervisory information, like for example the slave address. Strictly speaking, including a slave address would not be necessary in synchronous packets, since the time slot reservation already indicates the slave. However, by this concept, asynchronous packets can be multiplexed in synchronous time slots, for example if time critical control information has to be sent to a certain slave which may be different from the slave associated with the reserved time slot. The synchronous connection is then interrupted for a short time in order to pass some high-priority data. More on this synchronous and asynchronous connection concept can be found in the US application “Multi-media protocol for slot-based communication systems,” by J. C. Haartsen, filed Jul. 7, 1999 (P10965).

Although they hop in frequency, collisions between uncoordinated systems operating in the same band cannot be prevented. For asynchronous data services, retransmission schemes can be applied to retransmit failed data packets at different points in time and frequency. However, this may cause delay which depends on the number of retransmissions. For real-time services like voice, variable delay is unacceptable. Therefore error correction protocols based on the retransmission of erroneous data cannot be applied. Instead sufficient protection must be included on the voice connection to overcome interference. This can be accomplished by using robust voice coding schemes like Continuous Variable Slope Delta (CVSD) modulation. CVSD is a waveform coding technique which is rather robust against random bit errors. However, if the voice is packetized like in Bluetooth, apart from bit errors, packet failures may occur due to errors in the leading parts (i.e. preamble and header) of the packet. This will lead to a complete loss of a voice segment or frame. Although CVSD is robust against bit errors, frame errors are more detrimental.

It is therefore desirable to provide a method and a means to provide robustness to voice links disturbed by interference causing the loss of complete speech frames.

It is emphasised that the term “comprises” or “comprising” is used in this specification to specify the presence of stated features, integers, steps or components, but does not preclude the addition of one or more further features, integers, steps or components, or groups thereof.

### SUMMARY OF THE INVENTION

The proposed method improves the quality of voice channels in the presence of interference by accepting the voice payload in the packet, even if the supervisory part of the packet (i.e. the packet header) fails the check. As a result, the number of packet failures is reduced considerably. The voice payload of the packet, which would normally be discarded at a header failure, may contain bit errors, but these are much less noticeable than when a complete voice frame would be discarded.

According to the present invention, there is provided a method of processing data packets in a packet-based communications system, the method comprising:

receiving a data packet having header and payload information; and

processing the payload information irrespective of the header information.

### BRIEF DESCRIPTION OF THE DRAWINGS

FIG. 1 illustrates an example of a slot-based communication channel according to the Bluetooth system;

FIG. 2 illustrates an example of the packet format in the Bluetooth system with a) for a data packet and b) for a voice packet;

FIG. 3 is a flow diagram of packet processing; and

FIG. 4 is a flow diagram of packet processing according to current embodiment.

### DETAILED DESCRIPTION OF THE PREFERRED EMBODIMENT

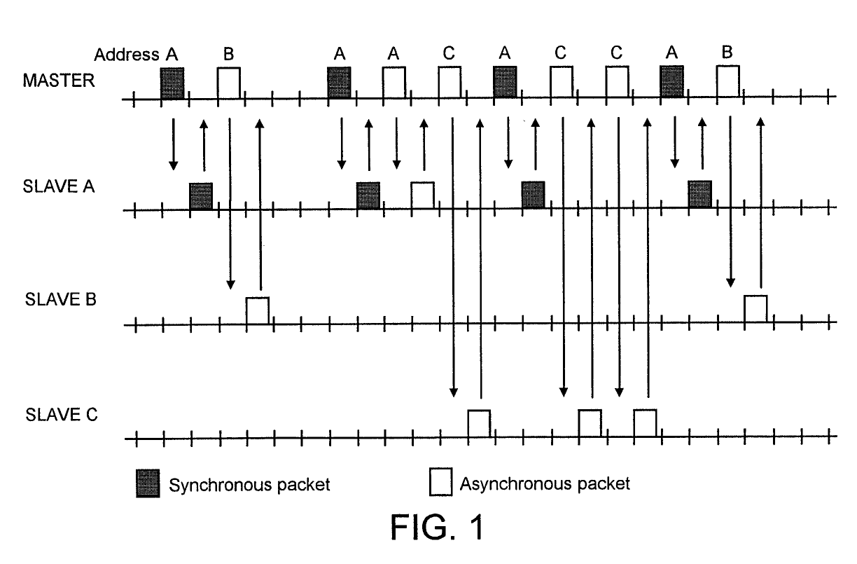

As described above, and as illustrated in FIG. 1, a new air interface has been defined to support short-range wireless connections. The interface, called Bluetooth is based on Frequency-hop/Time Division Duplex (FH/TDD) communications. A Bluetooth system supports piconets where a master forms a star network with a limited number of slaves. Packets are alternately transmitted and received in subsequent time slots; each time slot is at a different frequency. Synchronous links are established by reservation of time slots at regular intervals. The reserved slots provide a point-to-point circuit-switched connection between the master and a single slave. The master can simultaneously support a point-to-multipoint packet-switched connection to all the slaves on the non-reserved slots. At any slot instant, the master can decide which slave to address. Only the slave addressed in the master-to-slave time slot is allowed to respond in the following slave-to-master time slot.

This so-called polling scheme prevents multiple slaves to respond simultaneously which would result in collisions and a loss of information. FIG. 1 gives an example of a piconet where synchronous and asynchronous links are mixed.

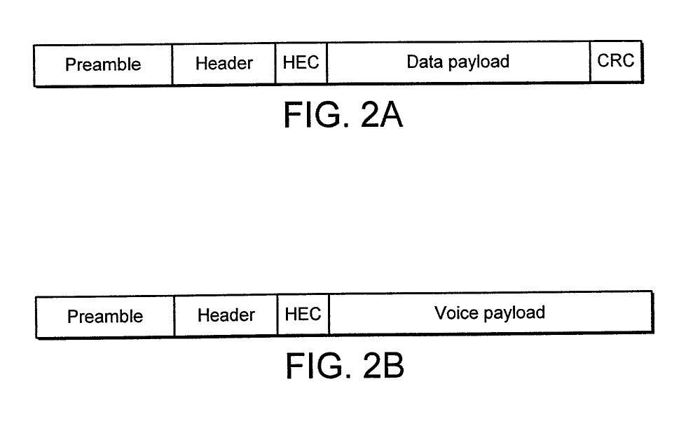

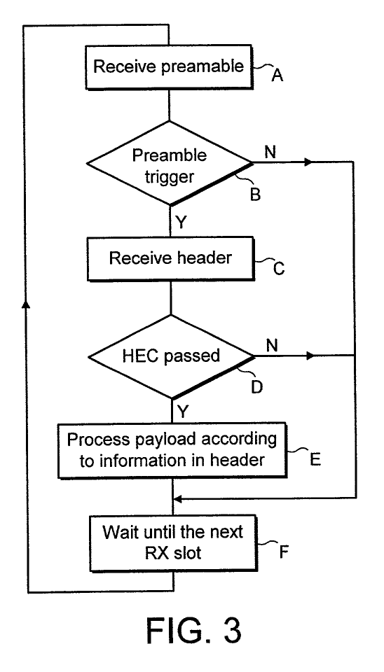

All packets in the Bluetooth have the same format: a preamble, a packet header, and a packet payload, see FIG. 2. The preamble is used for timing recovery and frequency compensation and is also used to identify the FH channel. Each piconet has a different preamble. The preamble identifies the piconet channel; all packets exchanged on this channel are preceded by the same preamble. FIG. 3 illustrates processing of a data packet. When the RX slot has arrived, the receiver is activated to receive the preamble (step A). Participants on the FH channel have a sliding correlator in the receiver which is matched (step B) to the identity code embedded in the preamble. Only if sufficient bits in the received preamble match with the expected code, the packet is accepted; otherwise the entire packet is discarded. In fact, if the correlator does not trigger at the beginning of a time slot, the receiver will go to sleep for the remaining part of the time slot, waking up again at the beginning of the next time slot in order to scan for a new packet (step F). This will reduce power consumption since the receiver will not have to scan continuously but can go to sleep rather quickly when it appears that either no packet was sent, or the error rate on the time slot is too high to expect sensible information. If the preamble contains N bits, the correlator only triggers if at least M out of the N bits match where M≦N. M is the trigger threshold and can be varied. If M is large, many false rejections may occur, i.e. packets are missed while they were actually present. If M is small, many false alarms may occur since the correlator will even trigger on preambles that are similar as the expected one, and even on random noise. After the preamble follows a packet header.

The packet header is only processed (steps C and D) after the correlator has triggered on the preamble. The receiver is then able to carry out the proper timing recovery and frequency compensation. This header contains link control information like the type of packet, error correction information, and a header error check (HEC). This header check is a cyclic redundancy (CRC) check to detect errors in the header (step D). If the check fails, the address and link information are not reliable and the packet is discarded; packet processing is stopped and the receiver is put to sleep until the beginning of the next receive slot (step F). When the HEC passes the test, the packet address can be properly decoded, the packet type is known and other link control information can be derived. Then the processing proceeds to handle the payload (step E).

In Bluetooth, there are three general packet types. The first type of packets are control packets. These packets have no payload (in this case only the preamble, or the preamble with the header for link control information is transmitted). The second type of packets carries asynchronous information like data in the payload. This payload is protected with a CRC, see FIG. 2a. If errors are detected, the payload is retransmitted by the sender. An Automatic Retransmission Query (ARQ) scheme is applied, the support for which is given by information in the packet header. Data does not allow errors, and for data integrity, the information has to be retransmitted until received error free. Typical residual-bit-error rates must be in the order of 10¹⁰. The third type of packets carries synchronous information like voice. Voice can allow same errors. CVSD coded voice can even allow bit error rates up to 1% before the listener experiences annoying disturbances. Therefore, the payload of the synchronous packets is not checked for errors but always accepted. Since the voice payload is not checked, it has no CRC, see FIG. 2b.

Since the voice payload on the synchronous packets is not checked for errors, the packet failure rate on the synchronous connections will be smaller than on the asynchronous connections for otherwise similar interference conditions. A synchronous service like speech will benefit from this since it can tolerate quite some errors due to the redundancy in the voice signal. However, the process flow in FIG. 3 shows that even a voice packet can be discarded when the correlator does not trigger and/or the header contains errors. The latter will be more likely, since the correlator operation is rather robust, especially when M is chosen not too close to N. The correlator has to trigger in order to carry out timing recovery and determine the start positions of header and payload. That the header failure affects the payload failure is a disadvantage, especially taking into account that the header information is not really useful for the voice recipient. The slave address information is inherent in the position of the reserved time slot, and the ARQ information is not used since the synchronous connection does not apply retransmissions.

In the current invention, the payload of a synchronous (voice) packet is accepted, even if the header check fails. If the packet is received in a time slot reserved for the synchronous service to a certain slave, header failures are ignored. That is, the header of a received packet is processed, but if the HEC fails, the payload is not discarded; instead, it is assumed that the address information corresponds to the slave associated with the reserved slot, and the voice payload is processed accordingly. The header information itself is discarded. If the HEC does check, the processing is done as before and the header information is used as well. Only if the header failure would coincide with an interruption of the synchronous link, erroneous processing maybe carried since a control payload is then erroneously regarded as a voice payload. However, the probability that this will happen is much smaller in ordinary conditions than a header failure in a voice packet.

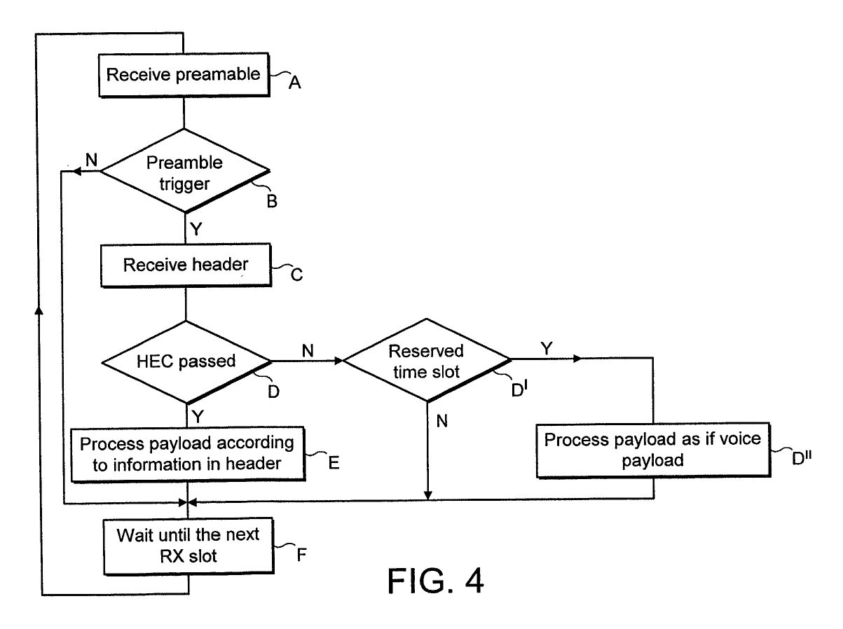

FIG. 4 illustrates an embodiment of the invention. If the HEC passes the test, processing is carried as in the conventional method (steps D to F). However, if the HEC fails, the time slot under consideration is tested (step DI). If it is a reserved time slot, then the header failure is ignored and the payload is processed assuming it is a synchronous packet (step DII). If the time slot is an unreserved slot, then the packet is discarded (step F).

1. A method of processing data packets in a packet-based communications system, the method comprising:
receiving a data packet having header and payload information; and
processing the payload information irrespective of the header information.

2. A method as claimed in claim 1, wherein payload information is processed assuming that the data packet is a synchronous data packet.

3. A method as claimed in claim 1, wherein the payload information of the data packet relates to voice information.

4. A method of processing data packets in a packet-based communications system, the data packets including header information and payload information, the method comprising:
receiving a data packet having header and payload information;
detecting errors in the header information; and
if no errors are detected, processing the payload information on the basis of the header information; or
if an error is detected, processing the payload information independently of the header information.

5. A method as claimed in claim 4, wherein payload information is processed assuming that the data packet is a synchronous data packet.

6. A method as claimed in claim 4, wherein the payload information of the data packet relates to voice information.

7. A method as claimed in claim 4, wherein the payload information is processed independently of the header information if the data packet is received in a reserved time slot.

8. A method of processing data packets in a packet-based communications system, the method comprising:
receiving a data packet having header and payload information;
determining the presence of errors in the header information;
if no errors are present in the header information, processing the payload information in accordance with the header information;
if an error is present in the header, determining if the received data packet was received in a reserved time slot, and
if so, processing the payload as synchronous data, or if not, discarding the data packet.

9. A method as claimed in claim 8, wherein the synchronous data is voice data.
